(19) United States
(12) Patent Application Publication
(10) Pub. No.: US 2004/0218998 A1
(43) Pub. Date: Nov. 4, 2004

(54) Hay bale mover

(76) Inventor: Ricky Thomas, Barry, TX (US)

Correspondence Address: DAVID G. HENRY, 7th Floor, 900 Washington Avenue, P.O. Box 1470, Waco, TX, 77603-1470, US

(21) Appl. No.: 10/426,028

(22) Filed: Apr. 29, 2003

(51) Int. Cl. A01D 85/00

(52) U.S. Cl. 414/24.5

(57) ABSTRACT

A multiple bale handing hay bale mover system with independently actuable tine arrays for independent handling of multiple hay bales.

### BACKGROUND OF THE INVENTION

1. Field of the Invention

The present invention relates to equipment for moving hay.

2. Background Information

Time is seldom on the side of farmers and ranchers. This is particularly true as farm and ranching profits are ever more squeezed by loss of subsidies, foreign competition, and rising labor costs, all of which translate into less hired help.

With this in mind, the time-consuming task of moving hay bales (mostly the large, round type of hay bales these days) is something which, if it could be streamlined, would be a good source of relief for farmers and ranchers (and hay sellers).

The present inventor is aware of existing hay movers, which attach to tractors, include a single tine for “spearing” a bale, and moving the bale from one location to another, but is not aware of any device which allows, not only the transport of multiple bales, but the independent manipulation (pickup, carry and drop off) of each of multiple bales.

Simply being able to move two bales at one time—picking up two bales delivering each to a selected locations—rather than making two round trips to move such bales will self-evidently cut in half the time consumed in using the present tractor-mounted bale movers.

It should be noted that simply adding additional tines to existing bale movers will not solve the present limitations of the existing bale movers, because all tines would operate in concert, thereby making it impossible, or at least impracticable, to selectively (and effectively) pickup and selectively drop off bales at will.

### SUMMARY OF THE INVENTION

In view of the foregoing, it is an object of the present invention to provide an improved hay bale mover apparatus which includes means for moving more than one hay bale at a time.

It is another object of the present invention to provide an improved hay bale mover apparatus which includes means for independently simultaneously manipulating and transporting multiple hay bales.

It is another object of the present invention to provide an improved hay bale mover apparatus which includes multiple tine arrays which are independently operable for picking up, transporting and depositing hay bales engaged with respective tine arrays.

In satisfaction of these and related objects, the present invention provides a design for an improved hay bale mover which is, in its preferred embodiment, designed for attaching to a tractor with accessory mounting hardware and hydraulic systems for actuating hydraulic cylinder-based accessories.

The present hay bale mover design includes a support frame to which are rotatably attached two tine arrays. Each tine array includes, in the preferred embodiment, two parallel tines which are designed to “spear” bales of hay. The tine arrays are attached to the support frame whereby they move from positions with the tines extending essentially along a ground surface (“pick-up and drop off orientation”), to a more upwardly projecting orientation (“transport orientation”) for carrying a hay bale from one location to another as the tractor carries the hay bale mover to which it is attached. Each tine array is linked to a hydraulic cylinder assembly which is configured for moving the tine arrays between the pick-up and drop off and the transport orientations.

Because the present design includes, not only multiple tine arrays, but also means for independently manipulating each array, an apparatus is presented which can effectively, simultaneously deal with the steps involved in acquiring, transporting, and depositing two, rather than one hay bale.

This invention also encompasses improved hay bale movers of the suggested design, but involving more than two tine arrays.

### BRIEF DESCRIPTION OF THE DRAWINGS

FIG. 1 is a perspective view of the preferred embodiment for the present improved hay bale mover design.

### DETAILED DESCRIPTION OF THE PREFERRED EMBODIMENT

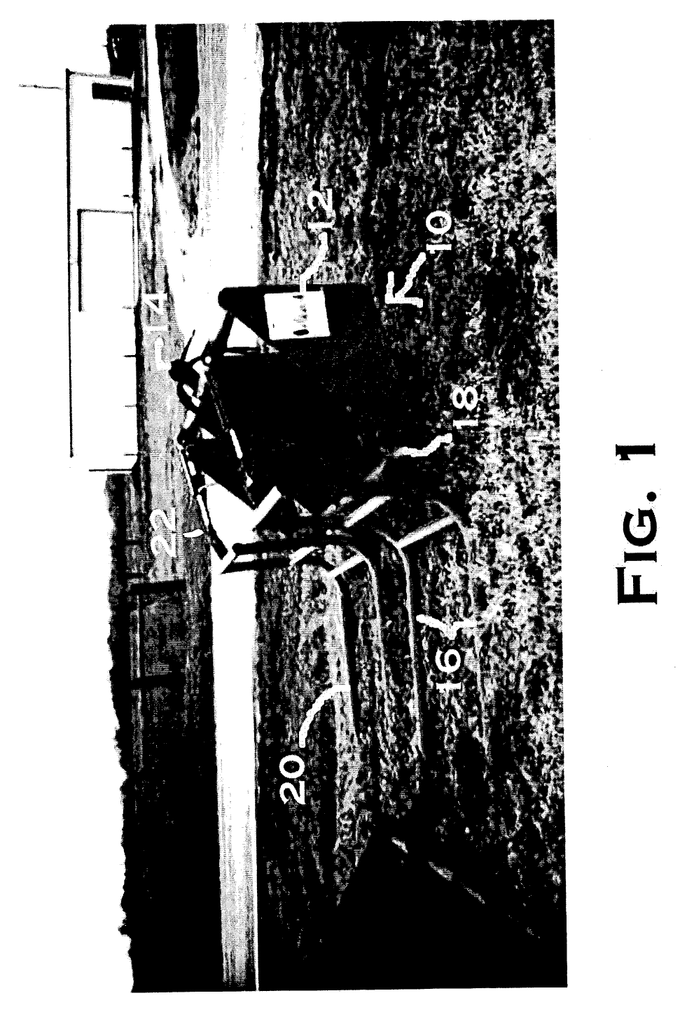

Referring to FIG. 1, the improved hay bale mover of the present invention is identified generally by the reference number 10. Mover 10 includes a support frame 12 with tractor attachment linkage 14 (note that a vehicle other than a tractor could be used with mover 10, and any reference to “tractor” merely indicates the expected, most common usage contexts).

First and second tine arrays 16 are rotatably mounted on a tine shaft 18 of support frame 12. Each tine array 16 includes, in the preferred embodiment, two tines 20 which are sized according to conventional standards for effectively “spearing” bales of hay. The appropriate size of tines 20 have no bearing on the present invention, and selecting same is well within the knowledge of anyone involved in making, or even using hay bale movers based, in part, on existing, prior art designs.

Attached to each tine array 16 and to the support frame 12 is a hydraulic assembly 22 which is positioned for respectively moving each of the two tine arrays 16 between its respective lowered, “pick-up and drop off orientation” (as shown in FIG. 1), and its raised, “transport orientation” (not shown in the drawings) in which the distal ends of the tines 20 are oriented upward for lifting a bale off the ground and transporting it from one location to another.

Each hydraulic assembly 22 utilizes standard hydraulic cylinder/piston assemblies as are used in any number of similar applications, and need not be described with any more specificity at this point for enabling disclosure purposes. Likewise, the controls for actuating each hydraulic assemblies 22 are well known in the art, and need not be shown nor described in this context.

As a result in including, not just multiple tine arrays 16, but means for independently actuating each tine array 16 for handing two bales independently of each other, a user of the present bale mover can literally turn two trips between pick-up and drop off locations into one. This, in turn, translates into substantial time savings, cost reductions (even fuel savings, because of reduced numbers of trips), and substantially greater convenience.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A hay bale mover comprising:
a support frame;
vehicle attachment means for attaching said support frame to a vehicle;
a tine shaft supported by said support frame;
a first tine array rotatably mounted to a first tine shaft segment whereby said first tine array is moveable between a first tine array pick-up and drop off orientation and a first tine array transport orientation;
first tine array actuation means attached to said first tine array for moving said first tine array between said first tine array pick-up and drop off orientation and said first tine array transport orientation;
a second tine array rotatably mounted to a second tine shaft segment whereby said second tine array is moveable between a second tine array pick-up and drop off orientation and a second tine array transport orientation;
second tine array actuation means attached to said second tine array for moving said second tine array between said second tine array pick-up and drop off orientation and said second tine array transport orientation.
